(19) United States
(12) Patent Application Publication
(10) Pub. No.: US 2025/0251931 A1
(43) Pub. Date: Aug. 7, 2025

(54) METHOD FOR DATA MANAGEMENT, MEDIUM, AND ELECTRONIC DEVICE

(71) Applicant: Beijing Youzhuju Network Technology Co., Ltd., Beijing (CN)

(72) Inventors: Haiwen Wu, Beijing (CN); Yunyun Xun, Beijing (CN); Sen Wang, Beijing (CN); Xiao Geng, Beijing (CN); Kang Yang, Beijing (CN); Hui Zhu, Beijing (CN); Tianyu Zhang, Beijing (CN)

(21) Appl. No.: 19/041,976

(22) Filed: Jan. 30, 2025

(30) Foreign Application Priority Data
Feb. 2, 2024 (CN) 202410155970.2

(51) Int. Cl. G06F 8/71; G06F 8/30

(52) U.S. Cl. CPC G06F 8/71; G06F 8/30

(57) ABSTRACT

The present disclosure relates to a method for data management, a medium, and an electronic device. The method includes: a configuration platform obtains target configuration data configured for a target business environment corresponding to a target environment identifier, the configuration platform generates a configuration file according to the target environment identifier and the target configuration data, a front-end platform obtains the configuration file corresponding to the target environment identifier from the configuration platform, the front-end platform renders and generates a front-end page corresponding to the target business environment according to the target configuration data included in the configuration file, a back-end server obtains the configuration file corresponding to the target environment identifier from the configuration platform, and the back-end server generates back-end code corresponding to the target business environment according to the target configuration data included in the configuration file.

### CROSS-REFERENCE TO RELATED APPLICATION

The present application claims the priority and benefits of Chinese Patent Application No. 202410155970.2, filed Feb. 2, 2024, which is incorporated herein by reference in its entirety as part of the present application.

### TECHNICAL FIELD

The present disclosure relates to a method for data management, a medium and an electronic device.

### BACKGROUND

With the development of computer technologies, front ends and back ends have become clearly differentiated in terms of technology stacks and programming languages. For example, front ends are increasingly inclined to use JSON (JavaScript Object Notation, JS object notation, which is a lightweight data exchange format), while back ends are increasingly inclined to use Golang (a statically strongly typed, compiled language) to implement functions. As a result, in the process of program development, it has become increasingly difficult to link front ends and back ends. For example, the difference in technology stacks between front ends and back ends becomes increasingly large, and modifications in back ends require recompilation and redeployment of code, which makes it more difficult for front ends and back ends to implement functions quickly at the same time. Often, modifications by multiple people in multiple environments are required to complete the development and release of a new function. Therefore, how to quickly link front ends and back ends has gradually become a technical problem that needs to be solved in the art.

### SUMMARY

The Summary is provided to introduce concepts in a simplified form that are described in detail in the following Detailed Description section. This Summary section is not intended to identify key features or essential features of the claimed technical solution, nor is it intended to be used to limit the scope of the claimed technical solution.

The present disclosure provides a method for data management, applied to a data management system, where the data management system includes a configuration platform, a front-end platform, and a back-end server, and the method includes:
obtaining, by the configuration platform, target configuration data configured for a target business environment corresponding to a target environment identifier, where the target configuration data is used for defining a function of the target business environment;
generating, by the configuration platform, a configuration file according to the target environment identifier and the target configuration data;
obtaining, by the front-end platform, the configuration file corresponding to the target environment identifier from the configuration platform;
performing, by the front-end platform, rendering according to the target configuration data included in the configuration file, to generate a front-end page corresponding to the target business environment;
obtaining, by the back-end server, a configuration file corresponding to the target environment identifier from the configuration platform; and
generating, by the back-end server, back-end code corresponding to the target business environment according to the target configuration data included in the configuration file, where the back-end code is used for supporting a function of the front-end page.

The present disclosure provides a method for data management, executed by a configuration platform, where the method includes:
obtaining target configuration data configured for a target business environment corresponding to a target environment identifier, where the target configuration data is used for defining a function of the target business environment;
generating a configuration file according to the target environment identifier and the target configuration data; and
sending the configuration file to a front-end platform and a back-end server, where the configuration file is used for the front-end platform to perform rendering according to the target configuration data included in the configuration file, to generate a front-end page corresponding to the target business environment, and the configuration file is used for the back-end server to generate back-end code corresponding to the target business environment according to the target configuration data included in the configuration file, where the back-end code is used for supporting the function of the front-end page.

The present disclosure provides a method for data management, executed by a back-end server, where the method includes:
obtaining a configuration file corresponding to a target environment identifier from a configuration platform, where the configuration file is generated by the configuration platform according to target configuration data configured for a target business environment corresponding to the target environment identifier and the target environment identifier, where the target configuration data is used for defining a function of the target business environment; and
generating back-end code corresponding to the target business environment according to the target configuration data included in the configuration file, where the back-end code is used for supporting a function of a front-end page.

The present disclosure provides a method for data management, executed by a front-end platform, where the method includes:
obtaining a configuration file corresponding to a target environment identifier from a configuration platform, where the configuration file is generated by the configuration platform according to target configuration data configured for a target business environment corresponding to the target environment identifier and the target environment identifier, where the target configuration data is used for defining a function of the target business environment; and
performing rendering according to the target configuration data included in the configuration file, to generate a front-end page corresponding to the target business environment.

The present disclosure provides a computer-readable medium, on which a computer program is stored, where when the program is executed by a processor, implements the method described above.

The present disclosure provides an electronic device, including:
a memory, on which a computer program is stored; and
a processor, configured to execute the computer program in the memory, to implement the method described above.

Other features and advantages of the present disclosure will be described in detail in the following detailed description section.

### BRIEF DESCRIPTION OF DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is an architecture diagram of a data management system according to some embodiments;

FIG. 2 is a flowchart of a method for data management according to an exemplary embodiment;

FIG. 3 is a schematic diagram of a configuration file according to an exemplary embodiment;

FIG. 4 is a schematic diagram of a configuration platform sending configuration files to a front-end platform and a back-end server according to an exemplary embodiment;

FIG. 5 is a schematic diagram of creating a target business environment according to an exemplary embodiment;

FIG. 6 is a schematic diagram of a configuration file according to yet another exemplary embodiment;

FIG. 7 is a flowchart of sending a configuration file to a front-end platform according to an exemplary embodiment;

FIG. 8 is a flowchart of a method for data management according to yet another exemplary embodiment;

FIG. 9 is a flowchart of a method for data management according to another exemplary embodiment;

FIG. 10 is a flowchart of a method for data management according to yet another exemplary embodiment;

FIG. 11 is a schematic diagram of module connection in a data management apparatus according to an exemplary embodiment;

FIG. 12 is a schematic diagram of module connection in a data management apparatus according to yet another exemplary embodiment;

FIG. 13 is a schematic diagram of module connection in a data management apparatus according to another exemplary embodiment; and

FIG. 14 is a structure diagram of an electronic device according to an exemplary embodiment.

### DETAILED DESCRIPTION

Embodiments of the present disclosure will be described in more detail below with reference to the drawings. While certain embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders, and/or performed in parallel. Furthermore, the method implementations may include additional steps and/or omit the steps illustrated in the drawings. The scope of the present disclosure is not limited in this regard.

The term “include” and variations thereof used herein are open-ended inclusions, that is, “include but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the order of functions performed by these apparatuses, modules or units or the interdependence relationship between these apparatuses, modules or units.

It should be noted that the modifiers “one” and “a plurality of” mentioned in the present disclosure are illustrative rather than restrictive, and those skilled in the art should understand that they should be understood as “one or more” unless the context clearly indicates otherwise.

The names of messages or information exchanged between multiple apparatuses in the implementations of the present disclosure are only for illustrative purposes, and are not intended to limit the scope of these messages or information.

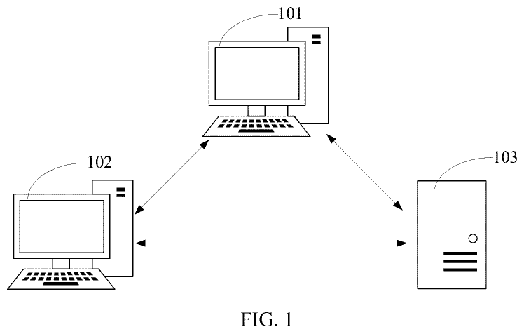

FIG. 1 is an architecture diagram of a data management system according to some embodiments. As shown in FIG. 1, the method for data management provided by the embodiments of the present disclosure is applicable to the system shown in FIG. 1, and the system may include a configuration platform 101, a front-end platform 102, and a back-end server 103. The configuration platform 101 and the front-end platform 102, the configuration platform 101 and the back-end server 103, and the back-end server 103 and the front-end platform 102 may communicate through wired connection or wireless connection.

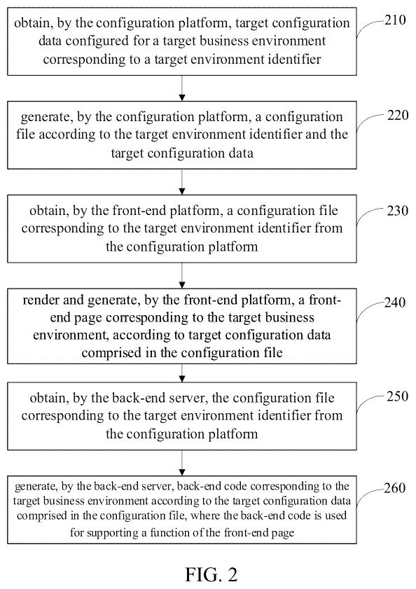

FIG. 2 is a flowchart of a method for data management according to an exemplary embodiment. As shown in FIG. 2, an embodiment of the present disclosure provides a method for data management, which may be applied to the data management system shown in FIG. 1. As shown in FIG. 2, the method may include the following steps.

In step 210, obtain, by the configuration platform, target configuration data configured for a target business environment corresponding to a target environment identifier.

The target business environment may refer to the business environment that the user needs to modify. In this embodiment of the present disclosure, the business environment may refer to a certain function of an application. For example, for an advertisement-type program, the business environment may refer to a function corresponding to a creation page, a function corresponding to a plan details page, and so on. In this embodiment of the present disclosure, the user may configure, through the configuration platform, the target configuration data corresponding to a certain function (equivalent to the target business environment). The target configuration data is used for defining the function corresponding to the target business environment. Defining the function corresponding to the target business environment refers to that the target configuration data determines the behavior, attribute, etc. of the function corresponding to the target business environment. For example, the target configuration data is to add a field in the page corresponding to the target business environment. Correspondingly, the page corresponding to the target business environment may display the field, and the back-end server may recognize the meaning of the field.

Each business environment is associated with a corresponding environment identifier, so as to distinguish different business environments globally through the environment identifier. The environment identifier may be an environment name or ID (Identity Document, unique identifier) corresponding to the business environment.

In the configuration platform, the user may create different target business environments and configure corresponding target configuration data for the target business environments. The configuration platform may receive an input instruction of the user for the target environment identifier, determine the target business environment corresponding to the target environment identifier that the user needs to modify, and then receive the target configuration data configured for the target business environment that is input by the user. For example, the user may input, through a user interface provided by the configuration platform, the target environment identifier corresponding to the business environment that needs to be adjusted, and then input, in the user interface, the target configuration data configured for the target business environment corresponding to the target environment identifier.

In the configuration platform, the user may configure the corresponding target configuration data for multiple different target business environments. The target configuration data configured for different target business environments is only effective in the corresponding target business environments, and is not effective in other business environments. For example, the target configuration data configured for the business environment A may only determine the function corresponding to the business environment A, and does not affect the function of the business environment B.

For example, in the configuration platform, the user may use the target environment identifier to specifically configure the functions of a specific business environment. The target environment identifier is used for distinguishing the configuration data corresponding to different business environments, so that other functions in the business system will not be affected.

It should be understood that the target business environment corresponding to the target environment identifier may be a pre-created business environment, or a newly created business environment. For example, the target configuration data may be target configuration data configured for a brand-new business environment, and the target configuration data may also be target configuration data for modifying the data of a pre-existing business environment.

In step 220, generate, by the configuration platform, a configuration file according to the target environment identifier and the target configuration data.

After obtaining the target configuration data configured for the target business environment corresponding to the target environment identifier, the configuration platform associates the target configuration data with the target environment identifier to generate the configuration file. For example, the generated configuration file may be a data file in which the user modifies the function of the target business environment.

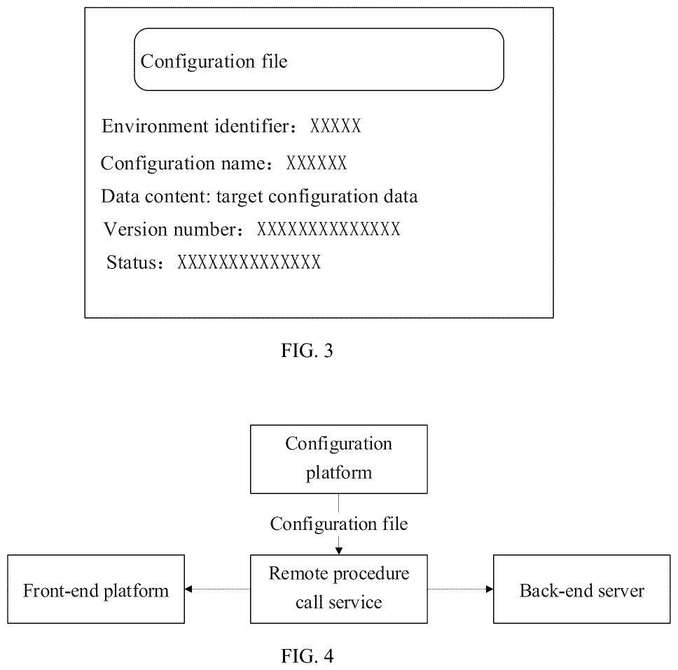

The configuration file may be a configuration file in JSON format. FIG. 3 is a schematic diagram of a configuration file according to an exemplary embodiment. As shown in FIG. 3, the configuration file may include a target environment identifier and data content, and the data content includes the target configuration data. Of course, the data content may also include other content. The data content may be written in JSON format. The configuration file may also include other data information, such as configuration name, version number, and status. The configuration name may be used to represent the function name corresponding to the target configuration data, the version number is used to represent the version information of the configuration file, and the status is used to represent the status information of the configuration file, such as whether it has been processed.

It should be noted that the generated configuration file is a configuration file that can be used by the front end (front-end platform) and the back end (back-end server), respectively. For example, the generated configuration file is a configuration file in the same format for the front end and the back end, and both the front end and the back end can use the configuration file to configure the functions.

In step 230, obtain, by the front-end platform, a configuration file corresponding to the target environment identifier from the configuration platform.

The front-end platform may obtain the configuration file corresponding to the target environment identifier from the configuration platform through a communication connection with the configuration platform.

As some examples, the configuration platform may actively distribute the configuration file corresponding to the target environment identifier to the front-end platform, and the front-end platform receives the configuration file sent by the configuration platform.

As yet some examples, the front-end platform may request the configuration file corresponding to the target environment identifier from the configuration platform based on the target environment identifier, and receive the configuration file corresponding to the target environment identifier sent by the configuration platform in response to the request sent by the front-end platform.

In this embodiment of the present disclosure, the front-end platform may actively obtain the configuration file corresponding to the target environment identifier from the configuration platform. The front-end platform may also passively receive the configuration file corresponding to the target environment identifier distributed by the configuration platform. In specific implementation, for different business environments, the configuration files may be obtained from the configuration platform in different ways.

In some embodiments, the configuration platform may send the configuration file corresponding to the target environment identifier to the front-end platform through a remote procedure call (Remote Procedure Call, RPC) service.

In step 240, render and generate, by the front-end platform, a front-end page corresponding to the target business environment, according to target configuration data included in the configuration file.

The front-end page rendered and generated by the front-end platform according to the target configuration data is a page corresponding to the target business environment, and the front-end page includes a function corresponding to the target configuration data. For example, when the target configuration data includes a new field, the front-end page corresponding to the target business environment rendered and generated according to the target configuration data also displays the new field. For another example, in response to the target business environment is a function corresponding to a plan details page, when the target configuration data indicates to add a new field in the plan details page, the rendered and generated plan details page includes the new field.

For example, for different target business environments, the manner of rendering and generating the front-end page corresponding to the target business environment may be different, which depends on the business logic corresponding to the target business environment. For example, in response to the target business environment is a creation page, the front-end platform obtains the configuration file corresponding to the creation page, and renders and generates the creation page. When the user uses the creation page for configuration, the front-end platform calls the creation interface corresponding to the creation page to obtain the configuration of the creation interface, and uses the configuration of the creation interface to call the back-end code corresponding to the back-end server to implement the corresponding function. For another example, in response to the target business environment is a plan details page, the front-end platform calls the creation interface corresponding to the plan details page in response to an operation of opening the plan details page, obtains the plan scene configuration and the scene details configuration corresponding to the plan details page through the creation interface, and renders and generates the plan details page based on the plan scene configuration and the scene details configuration in combination with the corresponding configuration file.

For example, the front-end page generated by the front-end platform through rendering may be in a format corresponding to the development environment of the front-end platform. For example, when the front-end platform uses a development environment in JSON format, the front-end page generated through rendering based on the configuration file is also in JSON format.

In step 250, obtain, by the back-end server, the configuration file corresponding to the target environment identifier from the configuration platform.

The back-end server may obtain the configuration file corresponding to the target environment identifier from the configuration platform through a communication connection with the configuration platform.

As some examples, the configuration platform may actively distribute the configuration file corresponding to the target environment identifier to the back-end server, and the back-end server receives the configuration file sent by the configuration platform.

As yet some examples, the back-end server may request the configuration file corresponding to the target environment identifier from the configuration platform based on the target environment identifier, and receive the configuration file corresponding to the target environment identifier sent by the configuration platform in response to the request sent by the back-end server.

In this embodiment of the present disclosure, the back-end server may actively obtain the configuration file corresponding to the target environment identifier from the configuration platform. The back-end server may also passively receive the configuration file corresponding to the target environment identifier distributed by the configuration platform. In specific implementation, for different business environments, the configuration files may be obtained from the configuration platform in different ways.

In some embodiments, the configuration platform may send the configuration file corresponding to the target environment identifier to the back-end server through a remote procedure call service.

FIG. 4 is a schematic diagram of a configuration platform sending configuration files to a front-end platform and a back-end server according to an exemplary embodiment. As shown in FIG. 4, the configuration platform sends the configuration files to the front-end platform and the back-end server through the remote procedure call service.

In step 260, generate, by the back-end server, back-end code corresponding to the target business environment according to the target configuration data included in the configuration file, where the back-end code is used for supporting a function of the front-end pageback-end code.

The back-end server uses the target configuration data included in the configuration file to generate the corresponding back-end code, and the back-end code is used for supporting the function of the front-end page. The back-end code being used for supporting the function of the front-end page refers to that the back-end code can understand the meaning of the function provided by the front-end page. For example, the target configuration data is to add a field in the front-end page corresponding to the target business environment. Correspondingly, the front-end page corresponding to the target business environment may display the field, and the back-end code deployed in the back-end server can recognize the meaning of the field and perform a corresponding operation.

For example, assuming that the development environment of the back-end server is in the form of Golang code, the back-end server generates the back-end code in Golang format based on the target configuration data included in the configuration file.

The above steps 230 to 240 and steps 250 to 260 may be executed simultaneously. For example, at the same time when the front-end platform renders and generates the front-end page based on the configuration file, the back-end server may also generate the back-end code based on the configuration file.

Therefore, the configuration platform obtains the target configuration data configured for the target business environment corresponding to the target environment identifier, the configuration platform generates the configuration file according to the target environment identifier and the target configuration data, the front-end platform obtains the configuration file corresponding to the target environment identifier from the configuration platform, the front-end platform renders and generates the front-end page corresponding to the target business environment according to the target configuration data included in the configuration file, the back-end server obtains the configuration file corresponding to the target environment identifier from the configuration platform, and the back-end server generates the back-end code corresponding to the target business environment according to the target configuration data included in the configuration file, so that front-end developers and back-end developers can use the environment identifiers in the configuration platform to configure the functions corresponding to different business environments, to release new product functions, etc., In addition, through the configuration file, the configuration file can be effective simultaneously in the entire chain of business of the front-end platform and the back-end server, thereby enabling the front-end platform and the back-end server to implement the release of the function at the same time. In addition, the configuration platform distributes the configuration file of the target business environment to the front-end platform and the back-end server, so that the front end and the back end can use the configuration data corresponding to the same configuration file for development without the problem of inconsistent business environments, thereby enabling data linking between the front end and the back end. In addition, based on the method provided in the embodiment of the present disclosure, the front end and the back end can complete the release of the function without additional code development, which greatly improves the development efficiency.

In some possible implementations, the configuration platform determines the target business environment according to the environmental creation information carried in the creation request in response to the creation request used to indicate to create a business environment, and the configuration platform establishes an association relationship between the target business environment and the target environment identifier according to the target environment identifier indicated by the creation request.

The configuration platform may provide a corresponding user interface, and the user inputs the creation request used to indicate to create a business environment in the user interface. The configuration platform creates the target business environment according to the environmental creation information indicated by the creation request in response to the creation request.

The environmental creation information includes at least one selected from the group of a basic source environment, requirement information associated with the target business environment, and a code name corresponding to branch code associated with the target business environment.

For example, the basic source environment may refer to the business environment on which the target business environment is based for establishment. For example, when a function A is a new function obtained by further developing a function B, the function B is the basic source environment of the function A. The requirement information may refer to the requirement document corresponding to the target business environment. The code name corresponding to the branch code may refer to the name of the branch code used by the target business environment, and the branch code may also be branch code inherited from the basic source environment.

For example, the user may create different business environments through the configuration platform, so that the front-end platform and the back-end server may use the configuration file corresponding to the same business environment to configure the corresponding functions, thereby ensuring coordination between the front end and the back end.

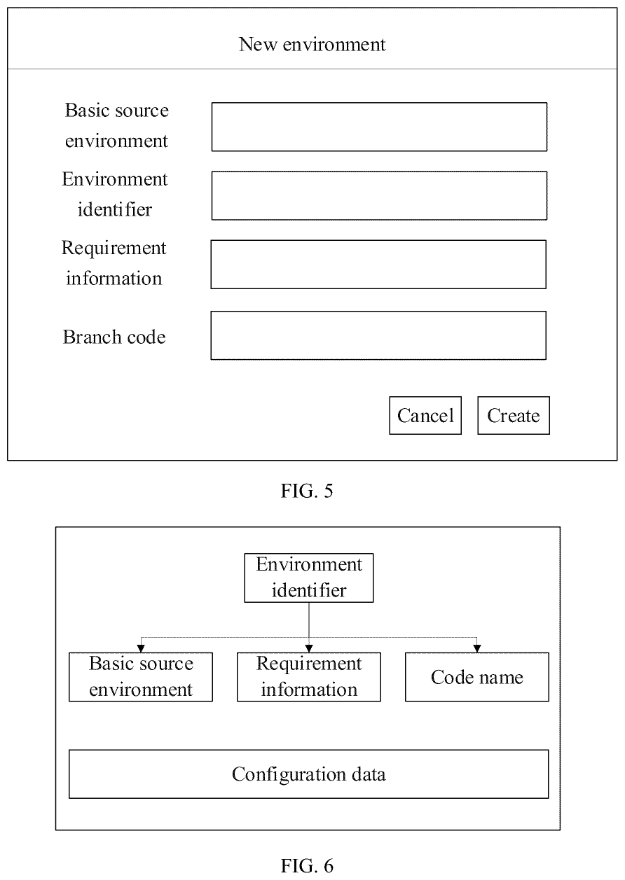

FIG. 5 is a schematic diagram of creating a target business environment according to an exemplary embodiment. As shown in FIG. 5, the user may input the corresponding basic source environment, environment identifier, requirement information, and code name corresponding to the branch code in the new environment interface of the configuration platform to create a target business environment.

The creation request may also carry the target environment identifier. The configuration platform creates the target business environment according to the environmental creation information carried in the creation request, and associates the created target business environment with the target environment identifier. The environment identifier may be used to distinguish different business environments, that is, the environment identifier points to a unique business environment. In this way, when the front end and the back end develop the function of the target business environment, the target configuration data that defines the function of the target business environment may be obtained through the corresponding target environment identifier, thereby achieving data isolation between different business environments. The configuration data configured for one business environment will not affect the function of another business environment.

FIG. 6 is a schematic diagram of a configuration file according to yet another exemplary embodiment. As shown in FIG. 6, the environment identifier is associated with a basic source environment, requirement information, and a code name, which constitutes an association relationship between an environment identifier and a business environment. In the business environment indicated by the environment identifier, the user may configure the required configuration data, thereby determining the function of the corresponding business environment.

Therefore, the configuration platform may establish different business environments associated with environment identifiers through creation requests, so that the user may perform data configuration for different business environments through the configuration platform. Moreover, the business environments are uniquely identified through the environment identifiers, which may achieve data isolation between different business environments.

In some possible implementations, the data management system may further include a storage center and a backend for front end (BFF) service. The storage center may be a high-speed cache platform to avoid storing too much data in the configuration platform.

It should be noted that the storage center may be set up separately or may be set up on the back-end server. The BFF service may be set up separately or may be set up on the front-end platform.

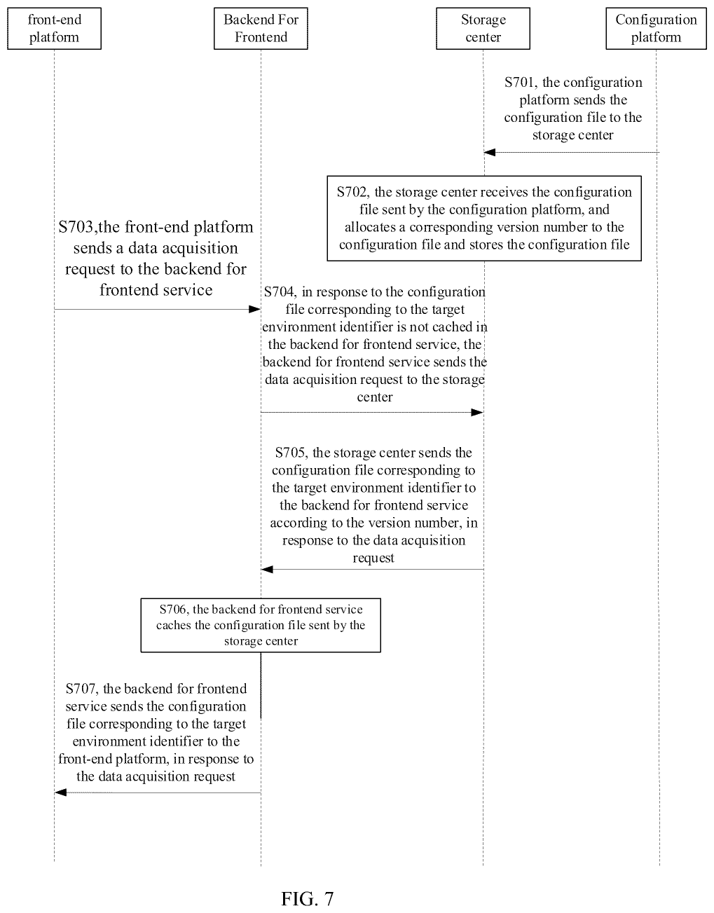

FIG. 7 is a flowchart of sending a configuration file to a front-end platform according to an exemplary embodiment. As shown in the figure, the configuration file may be sent to the front-end platform through the following steps.

S701, the configuration platform sends the configuration file to the storage center.

S702, the storage center receives the configuration file sent by the configuration platform, and allocates a corresponding version number to the configuration file and stores the configuration file.

S703, the front-end platform sends a data acquisition request to the backend for frontend service.

S704, in response to the configuration file corresponding to the target environment identifier is not cached in the backend for frontend service, the backend for frontend service sends the data acquisition request to the storage center.

S705, the storage center sends the configuration file corresponding to the target environment identifier to the backend for frontend service according to the version number, in response to the data acquisition request.

S706, the backend for frontend service caches the configuration file sent by the storage center.

S707, the backend for frontend service sends the configuration file corresponding to the target environment identifier to the front-end platform, in response to the data acquisition request.

After generating the configuration file, the configuration platform updates the generated configuration file to the storage center. The configuration platform may update the generated configuration file to the storage center through an HTTP (Hypertext Transfer Protocol) service. For example, after generating the configuration file, the configuration platform may send the configuration file to the storage center through the HTTP service. The storage center receives the configuration file sent by the configuration platform, allocates a corresponding version number to the configuration file, and stores the configuration file based on the version number.

It should be understood that the version number of the configuration file may refer to an identification number of the version of the configuration text, and the old and new of the configuration text may be determined through the version number. The storage center is responsible for publishing the version number corresponding to each configuration file, so as to ensure the orderly update of the configuration file through the version number.

When the front-end platform needs to request the configuration file corresponding to the target environment identifier, the front-end platform sends a data acquisition request including the target environment identifier to the BFF service. In response to the data acquisition request, the BFF service determines whether the BFF service has the configuration file corresponding to the target environment identifier cached therein. In response to the configuration file corresponding to the target environment identifier is not cached in the BFF service, the BFF service forwards the data acquisition request sent by the front-end platform to the storage center.

The storage center sends the configuration file corresponding to the target environment identifier to the BFF service according to the version number in response to the data acquisition request. The storage center may send the latest version of the configuration file corresponding to the target environment identifier to the BFF service, so as to ensure that the front-end platform may rendering and generating the corresponding front-end page according to the latest configuration file.

The BFF service caches the configuration file corresponding to the target environment identifier sent by the storage center, and sends the configuration file corresponding to the target environment identifier to the front-end platform in response to the data acquisition request sent by the front-end platform, so that the front-end platform performs rendering and generating the corresponding front-end page according to the configuration file.

Therefore, through the above implementations, the configuration platform may obtain the latest configuration file of the target business environment. Moreover, through the storage center and the BFF service, the overall performance of the system may be improved, avoiding storing too many configuration files in the configuration platform, and greatly ensuring the performance of the configuration platform.

In some possible implementations, in response to the configuration file corresponding to the target environment identifier is cached in the BFF service, when a first time interval between a timestamp of the cached configuration file corresponding to the target environment identifier and a current time is less than a second time interval for the storage center to update the configuration file to the backend for frontend service, the backend for frontend service sends the cached configuration file corresponding to the target environment identifier in response to the data acquisition request.

When the BFF service has the configuration file corresponding to the target environment identifier cached therein, the BFF service further determines that a first time interval between a timestamp of the cached configuration file corresponding to the target environment identifier and a current time is less than a second time interval for the storage center to update the configuration file to the backend for frontend service. The timestamp of the configuration file refers to the time when the BFF service receives and caches the configuration file. The current time refers to the global time of the system. Therefore, the first time interval refers to the time interval between the time when the storage center updates the configuration file to the BFF service and the current time. The second time interval refers to the time interval for the storage center to regularly update the configuration file to the BFF service. For example, the second time interval may be 1 minute.

In response to the first time interval is less than the second time interval, it indicates that the storage center has not updated the configuration file to the BFF service yet. For example, the configuration file cached in the BFF service may be understood as the latest version of the configuration file. Therefore, the BFF service may send the cached configuration file corresponding to the target environment identifier to the front-end platform, so that the configuration platform renders and generates the front-end page according to the cached configuration file.

It should be noted that when the first time interval is greater than or equal to the second time interval, it indicates that the storage center has updated the configuration file, and the cached configuration file on the BFF service will not be used any more. Instead, the BFF service requests a new configuration file from the storage center.

Therefore, through the above implementations, in response to the storage center does not update the cached configuration file, the front-end platform may use the cache on the BFF service to render and generate the front-end page.

In some possible implementations, the configuration file further includes a code name corresponding to branch code associated with the target business environment. Correspondingly, the back-end server generates the back-end code according to the target configuration data and the code name included in the configuration file.

The back-end server may obtain the corresponding branch code based on the code name, and then generate the back-end code that supports the front-end page based on the branch code and the target configuration data.

Exemplarily, the back-end server may write the target configuration data into the branch code, so that the branch code can execute the function corresponding to the target configuration data, thereby generating the back-end code that supports the front-end page. Of course, the back-end server may generate new back-end code based on the target configuration data into the branch code corresponding to the code name.

In some embodiments, the back-end server may convert the configuration file in the first format into a configuration file in an intermediate format through a preset script, and the back-end server may generate the back-end code in a second format through a code generator based on the target configuration data and the code name included in the configuration file in the intermediate format.

The first format may be a JSON format, the intermediate format may be a YAML format (a format with high readability, used to express data serialization), and the third format may be a Golang format. It should be noted that the first format may refer to a format used to unify the front-end platform and the back-end server. For example, the first format may be a configuration file in a unified format for the front-end platform and the back-end server. The third format may be understood as a format corresponding to the development environment adopted by the back-end server.

The preset script is used to convert the configuration file in the first format into the configuration file in the intermediate format. Exemplarily, the preset script may be a Creation_gen script. By executing the Creation_gen script, the configuration file in the JSON format is converted into the configuration file in the YAML format.

It should be understood that the preset script actually parses the configuration file in the first format into a file in an intermediate format that can be recognized by the code generator.

The code generator is configured to generate the back-end code in the second format according to the target configuration data and the code name in the configuration file in the intermediate format. Exemplarily, the configuration file in the YAML format may be input to the code generator, and the code generator generates the back-end code in the third format based on the code name of the branch code and the target configuration data included in the configuration file in the YAML format.

It should be noted that the code generator actually generates the back-end code in the third format corresponding to the development environment used by the back-end server based on the configuration file in the intermediate format, so that the back-end code may be directly deployed in the back-end server.

Therefore, through the above implementations, the corresponding back-end code may be automatically generated, and the release of new functions may be implemented without the need for the user to manually develop code.

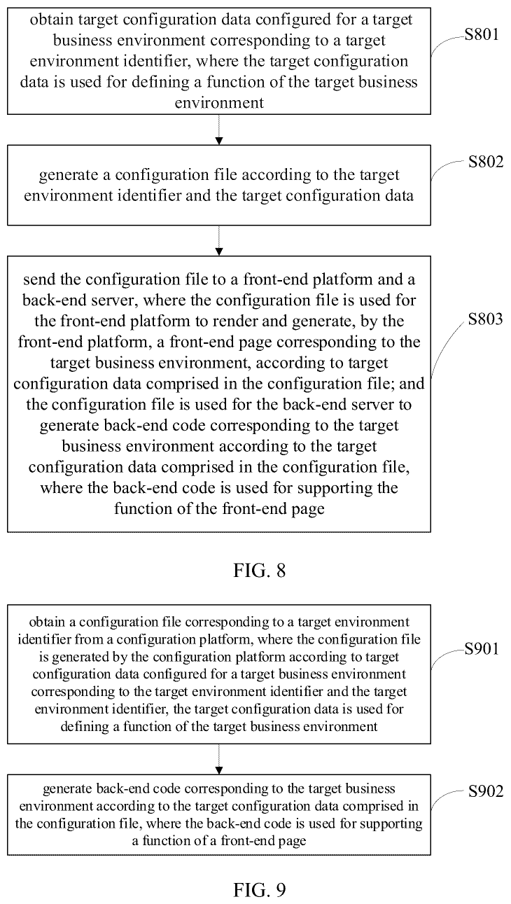

FIG. 8 is a flowchart of a method for data management according to yet another exemplary embodiment. As shown in FIG. 8, the method is executed by the configuration platform, and includes the following steps.

S801, obtain target configuration data configured for a target business environment corresponding to a target environment identifier, where the target configuration data is used for defining a function of the target business environment.

S802, generate a configuration file according to the target environment identifier and the target configuration data.

S803, send the configuration file to a front-end platform and a back-end server, where the configuration file is used for the front-end platform to render and generate, by the front-end platform, a front-end page corresponding to the target business environment, according to target configuration data included in the configuration file; and the configuration file is used for the back-end server to generate back-end code corresponding to the target business environment according to the target configuration data included in the configuration file, where the back-end code is used for supporting the function of the front-end page.

In some embodiments, the target business environment corresponding to the target environment identifier is established by:
determine the target business environment according to a basic source environment indicated by an environment establishment request, requirement information associated with the basic source environment, and a code name corresponding to branch code associated with the basic source environment in response to the environment establishment request used to indicate establishing the business environment; and
establish an association relationship between the target business environment and the target environment identifier according to the target environment identifier indicated by the environment establishment request.

In some embodiments, in step S803, send the configuration file to the front-end platform includes:
update the configuration file to a storage center, so as to send the configuration file to the front-end platform through the storage center;
where the storage center is configured to receive the configuration file sent by the configuration platform, and allocate a version number to the configuration file and store the configuration file in the storage center;
the storage center is further configured to send, in response to a data acquisition request sent by the front-end platform through the BFF service, a configuration file corresponding to the target environment identifier and the version number indicated by the data acquisition request to the BFF service; and
the BFF service is configured to store the configuration file corresponding to the target environment identifier and the version number sent by the storage center, and send the configuration file corresponding to the target environment identifier and the version number to the front-end platform in response to the data acquisition request.

For detailed descriptions of the above embodiments, reference may be made to the related descriptions of the embodiments shown in FIG. 2, which will not be repeated here.

FIG. 9 is a flowchart of a method for data management according to another exemplary embodiment. As shown in FIG. 9, the method is executed by the back-end server, and includes the following steps.

S901, obtain a configuration file corresponding to a target environment identifier from a configuration platform, where the configuration file is generated by the configuration platform according to target configuration data configured for a target business environment corresponding to the target environment identifier and the target environment identifier, the target configuration data is used for defining a function of the target business environment.

S902, generate back-end code corresponding to the target business environment according to the target configuration data included in the configuration file, where the back-end code is used for supporting a function of a front-end page.

In some embodiments, the configuration file further includes a code name corresponding to branch code associated with the target business environment. Correspondingly, the back-end server generates the back-end code according to the target configuration data and the code name included in the configuration file.

In some embodiments, the back-end server converts the configuration file in the first format into a configuration file in an intermediate format through a preset script, and the back-end server generates the back-end code in a second format through a code generator based on the target configuration data and the code name included in the configuration file in the intermediate format.

For detailed descriptions of the above embodiments, reference may be made to the related descriptions of the embodiments shown in FIG. 2, which will not be repeated here.

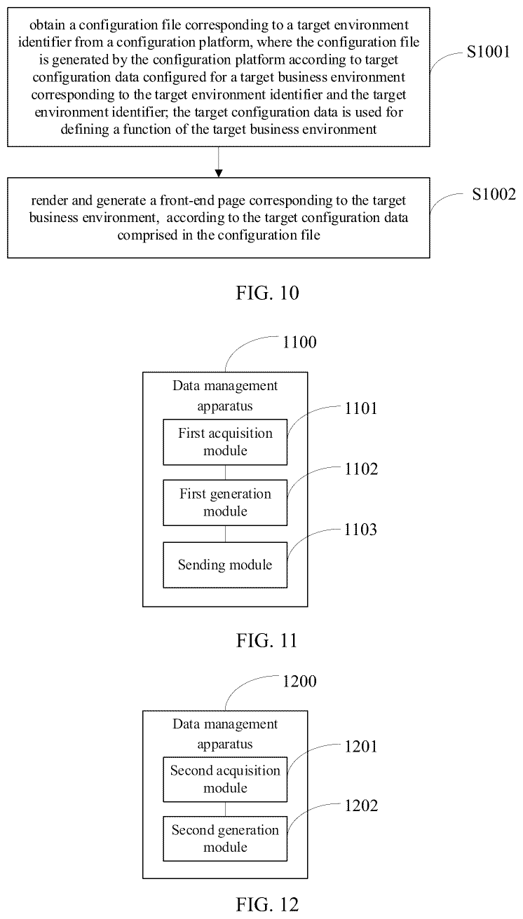

FIG. 10 is a flowchart of a method for data management according to yet another exemplary embodiment. As shown in FIG. 10, the method is executed by the front-end platform, and includes the following steps.

S1001, obtain a configuration file corresponding to a target environment identifier from a configuration platform, where the configuration file is generated by the configuration platform according to target configuration data configured for a target business environment corresponding to the target environment identifier and the target environment identifier; the target configuration data is used for defining a function of the target business environment.

S1002, render and generate a front-end page corresponding to the target business environment, according to the target configuration data included in the configuration file.

For detailed descriptions of the above embodiments, reference may be made to the related descriptions of the embodiments shown in FIG. 2, which will not be repeated here.

FIG. 11 is a schematic diagram of module connection in a data management apparatus according to an exemplary embodiment. As shown in FIG. 11, an embodiment of the present disclosure provides a data management apparatus 1100, and the data management apparatus 1100 is provided in a configuration platform. The data management apparatus 1100 includes:

A first acquisition module 1101 is configured to obtain target configuration data configured for a target business environment corresponding to a target environment identifier, where the target configuration data is used for defining a function of the target business environment.

A first generation module 1102 is configured to generate a configuration file according to the target environment identifier and the target configuration data.

A sending module 1103 is configured to send the configuration file to a front-end platform and a back-end server, where the configuration file is used for the front-end platform to render and generate a front-end page corresponding to the target business environment according to the target configuration data included in the configuration file, and the configuration file is used for the back-end server to generate back-end code corresponding to the target business environment according to the target configuration data included in the configuration file, where the back-end code is used for supporting the function of the front-end page.

In some embodiments, the data management apparatus 1100 further includes:

A determination module is configured to determine the target business environment according to a basic source environment indicated by an environment establishment request, requirement information associated with the basic source environment, and a code name corresponding to branch code associated with the basic source environment in response to the environment establishment request used to indicate establishing the business environment.

An establishment module is configured to establish an association relationship between the target business environment and the target environment identifier according to the target environment identifier indicated by the environment establishment request.

In some embodiments, the sending module 1103 is specifically configured to:
update the configuration file to a storage center, to send the configuration file to the front-end platform through the storage center;
where the storage center is configured to receive the configuration file sent by the configuration platform, and allocate a version number to the configuration file and store the configuration file in the storage center;
the storage center is further configured to send, in response to a data acquisition request sent by the front-end platform through a BFF service, a configuration file corresponding to the target environment identifier and the version number indicated by the data acquisition request to the BFF service; and
the BFF service is configured to store the configuration file corresponding to the target environment identifier and the version number sent by the storage center, and send the configuration file corresponding to the target environment identifier and the version number to the front-end platform in response to the data acquisition request.

For the logic of the method executed by each functional module in the above data management apparatus 1100, reference may be made to the method part related to the above embodiments, which will not be repeated here.

FIG. 12 is a schematic diagram of module connection in a data management apparatus according to yet another exemplary embodiment. As shown in FIG. 12, an embodiment of the present disclosure provides a data management apparatus 1200, and the data management apparatus 1200 is provided in a back-end server. The apparatus 1200 includes:

A second acquisition module 1201 is configured to obtain a configuration file corresponding to a target environment identifier from a configuration platform, where the configuration file is generated by the configuration platform according to target configuration data configured for a target business environment corresponding to the target environment identifier and the target environment identifier, where the target configuration data is used for defining a function of the target business environment.

A second generation module 1202 is configured to generate back-end code corresponding to the target business environment according to the target configuration data included in the configuration file, where the back-end code is used for supporting a function of a front-end page.

In some embodiments, the configuration file further includes a code name corresponding to branch code associated with the target business environment. Correspondingly, the second generation module 1202 is specifically configured to:

generate the back-end code according to the target configuration data and the code name included in the configuration file.

In some embodiments, the second generation module 1202 is specifically configured to:
convert the configuration file in the first format into a configuration file in an intermediate format through a preset script, and generate the back-end code in the second format through a code generator based on the target configuration data and the code name included in the configuration file in the intermediate format.

For the logic of the method executed by each functional module in the above data management apparatus 1200, reference may be made to the method part related to the above embodiments, which will not be repeated here.

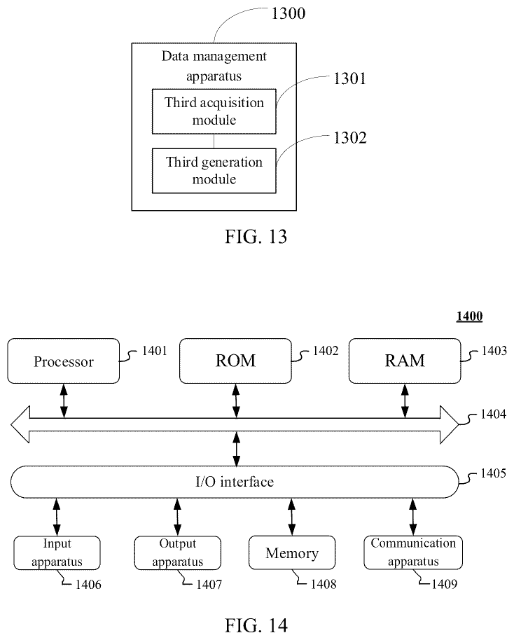

FIG. 13 is a schematic diagram of module connection in a data management apparatus according to another exemplary embodiment. As shown in FIG. 13, an embodiment of the present disclosure provides a data management apparatus 1300, and the data management apparatus 1300 is provided in a front-end platform. The apparatus 1300 includes:

A third acquisition module 1301 is configured to obtain a configuration file corresponding to a target environment identifier from a configuration platform, where the configuration file is generated by the configuration platform according to target configuration data configured for a target business environment corresponding to the target environment identifier and the target environment identifier, where the target configuration data is used for defining a function of the target business environment.

A third generation module 1302 is configured to render and generate a front-end page corresponding to the target business environment according to the target configuration data included in the configuration file.

For the logic of the method executed by each functional module in the above data management apparatus 1300, reference may be made to the method part related to the above embodiments, which will not be repeated here.

Reference will now be made to FIG. 14 below, which illustrates a structure diagram of an electronic device (such as the front-end platform, the configuration platform, or the back-end server in FIG. 1) 1400 suitable for implementing the embodiments of the present disclosure. The terminal devices in the embodiments of the present disclosure may include, but are not limited to, mobile terminals such as mobile phones, laptop computers, digital broadcast receivers, PDAs (Personal Digital Assistants), PADs (tablet computers), PMPs (Portable Multimedia Players), vehicle-mounted terminals (such as vehicle-mounted navigation terminals), etc., and fixed terminals such as digital TVs, desktop computers, etc., The electronic device shown in FIG. 14 is only an example, and should not impose any limitation on the functions and scope of use of the embodiments of the present disclosure.

As shown in FIG. 14, the electronic device 1400 may include a processor (such as a central processing unit, a graphics processing unit, etc.) 1401, which may perform various appropriate actions and processes according to a program stored in a read-only memory (ROM) 1402 or a program loaded from a memory 1408 into a random access memory (RAM) 1403. In the RAM 1403, various programs and data required for the operation of the electronic device 1400 are also stored. The processor 1401, the ROM 1402, and the RAM 1403 are connected to each other through a bus 1404. An input/output (I/O) interface 1405 is also connected to the bus 1404.

Generally, the following apparatuses may be connected to the I/O interface 1405: an input apparatus 1406 including, for example, a touchscreen, a touchpad, a keyboard, a mouse, a camera, a microphone, an accelerometer, a gyroscope, and the like; an output apparatus 1407 including, for example, a liquid crystal display (LCD), a speaker, a vibrator, and the like; a memory 1408 including, for example, a magnetic tape, a hard disk, and the like; and a communication apparatus 1409. The communication apparatus 1409 may allow the electronic device 1400 to perform wireless or wired communication with other devices to exchange data. Although FIG. 14 shows the electronic device 1400 having various apparatuses, it should be understood that not all of the illustrated apparatuses are required to be implemented or provided. More or fewer apparatuses may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program includes program codes for performing the method shown in the flowchart. In such an embodiment, the computer program may be downloaded and installed from a network through the communication apparatus 1409, or may be installed from the memory 1408, or may be installed from the ROM 1402. When the computer program is executed by the processor 1401, the above functions defined in the method of the embodiment of the present disclosure are performed.

It should be noted that the above computer-readable medium in the present disclosure may be a computer-readable signal medium or a computer-readable storage medium, or any combination thereof. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program. The program may be used by or in combination with an instruction execution system, apparatus, or device. In the present disclosure, the computer-readable signal medium may include a data signal propagated in a baseband or as a part of a carrier, and computer-readable program codes are carried therein. The propagated data signal may take a variety of forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to: a wire, an optical cable, RF (Radio Frequency), etc., or any suitable combination of the above.

In some implementations, the front-end platform, the configuration platform, and the back-end server may communicate using any currently known or future-developed network protocol, such as HTTP (HyperText Transfer Protocol), and may be connected to digital data communication (for example, a communication network) in any form or medium. Examples of the communication network include a local area network (“LAN”), a wide area network (“WAN”), an internet network (for example, the Internet), and a peer-to-peer network (for example, an ad hoc peer-to-peer network), as well as any currently known or future-developed networks.

The above computer-readable medium may be included in the above electronic device, or may exist alone without being assembled into the electronic device.

The above computer-readable medium carries one or more programs, and when the above one or more programs are executed by the electronic device, the electronic device is caused to: obtain target configuration data configured for a target business environment corresponding to a target environment identifier, where the target configuration data is used for defining a function of the target business environment; generate a configuration file according to the target environment identifier and the target configuration data; and send the configuration file to a front-end platform and a back-end server, where the configuration file is used for the front-end platform to render and generate a front-end page corresponding to the target business environment according to the target configuration data included in the configuration file; and the configuration file is used for the back-end server to generate back-end code corresponding to the target business environment according to the target configuration data included in the configuration file, where the back-end code is used for supporting the function of the front-end page.

Alternatively, the above computer-readable medium carries one or more programs, and when the above one or more programs are executed by the electronic device, the electronic device is caused to: obtain a configuration file corresponding to a target environment identifier from a configuration platform, where the configuration file is generated by the configuration platform according to target configuration data configured for a target business environment corresponding to the target environment identifier and the target environment identifier, where the target configuration data is used for defining a function of the target business environment; and generate back-end code corresponding to the target business environment according to the target configuration data included in the configuration file, where the back-end code is used for supporting a function of a front-end page.

Alternatively, the above computer-readable medium carries one or more programs, and when the above one or more programs are executed by the electronic device, the electronic device is caused to: obtain a configuration file corresponding to a target environment identifier from a configuration platform, where the configuration file is generated by the configuration platform according to target configuration data configured for a target business environment corresponding to the target environment identifier and the target environment identifier, where the target configuration data is used for defining a function of the target business environment; and rendering and generating a front-end page corresponding to the target business environment according to the target configuration data included in the configuration file.

The computer program codes for performing the operations of the present disclosure may be written in one or more programming languages or a combination thereof. The above programming languages include, but are not limited to, object-oriented programming languages such as Java, Smalltalk, C++, and also include conventional procedural programming languages such as “C” language or similar programming languages. The program codes may be completely executed on a user computer, partially executed on a user computer, executed as an independent software package, partially executed on a user computer and partially executed on a remote computer, or completely executed on a remote computer or server. In the case involving a remote computer, the remote computer may be connected to the user computer through any kind of network, including a local area network (LAN) or a wide area network (WAN), or may be connected to an external computer (for example, using an Internet service provider to connect through the Internet).

The flowcharts and block diagrams in the drawings illustrate the architecture, functions, and operations of possible implementations of systems, methods, and computer program products according to various embodiments of the present disclosure. In this regard, each block in the flowchart or block diagram may represent a module, a program segment, or part of a code. The module, program segment, or part of the code contains one or more executable instructions for implementing a specified logical function. It should also be noted that in some alternative implementations, the functions marked in the blocks may also occur in a different order from the order marked in the drawings. For example, two blocks shown one after another may actually be executed substantially in parallel, and sometimes they may be executed in the reverse order, depending on the functions involved. It should also be noted that each block in the block diagram and/or flowchart, and a combination of blocks in the block diagram and/or flowchart, may be implemented by a dedicated hardware-based system that performs specified functions or operations, or may be implemented by a combination of dedicated hardware and computer instructions.

The modules involved in the embodiments of the present disclosure may be implemented in software or hardware. The name of a module does not constitute a limitation on the module itself under certain circumstances.

The functions described herein above may be performed, at least partially, by one or more hardware logic components. For example, without limitation, exemplary types of hardware logic components that may be used include: field Programmable Gate Array (FPGA), Application Specific Integrated Circuit (ASIC), Application Specific Standard Product (ASSP), System on Chip (SOC), Complex Programmable Logical Device (CPLD), etc..

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by the arbitrary combination of the above technical features or their equivalent features without departing from the above disclosed concept, for example, the technical solutions formed by replacing the above features with the technical features having similar functions disclosed in the present disclosure (but not limited to).

In addition, although operations are depicted in a particular order, this should not be understood as requiring that the operations be performed in the particular order shown or in a sequential order. Under certain circumstances, multitasking and parallel processing may be advantageous. Similarly, although several specific implementation details are included in the above discussion, these should not be construed as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms for implementing the claims. Regarding the apparatus in the above embodiments, the specific way in which each module performs operations has been described in detail in the method embodiments, and will not be described in detail here.

1. A method for data management, applied to a data management system, wherein the data management system comprises a configuration platform, a front-end platform, and a back-end server, and the method comprises:
obtaining, by the configuration platform, target configuration data configured for a target business environment corresponding to a target environment identifier, wherein the target configuration data is used for defining a function of the target business environment;
generating, by the configuration platform, a configuration file according to the target environment identifier and the target configuration data;
obtaining, by the front-end platform, a configuration file corresponding to the target environment identifier from the configuration platform;
rendering and generating, by the front-end platform, a front-end page corresponding to the target business environment, according to target configuration data comprised in the configuration file;
obtaining, by the back-end server, the configuration file corresponding to the target environment identifier from the configuration platform; and
generating, by the back-end server, back-end code corresponding to the target business environment according to the target configuration data comprised in the configuration file, wherein the back-end code is used for supporting a function of the front-end page.

2. The method according to claim 1, wherein the target business environment corresponding to the target environment identifier is established by:
determining, by the configuration platform, the target business environment according to environmental creation information carried in a creation request in response to the creation request used to indicate to create a business environment, wherein the environmental creation information comprises at least one selected from the group of a basic source environment, requirement information associated with the target business environment, and a code name corresponding to branch code associated with the target business environment; and
establishing, by the configuration platform, an association relationship between the target business environment and the target environment identifier according to the target environment identifier indicated by the creation request.

3. The method according to claim 1, wherein the data management system further comprises a storage center and a backend for frontend service, and the method further comprises:
sending, by the configuration platform, the configuration file to the storage center;
receiving, by the storage center, the configuration file sent by the configuration platform, allocating a corresponding version number to the configuration file and storing the configuration file; and
the obtaining, by the front-end platform, a configuration file corresponding to the target environment identifier from the configuration platform, comprises:
sending, by the front-end platform, a data acquisition request to the backend for frontend service, wherein the data acquisition request comprises the target environment identifier;
in response to the configuration file corresponding to the target environment identifier is not cached in the backend for frontend service, sending, by the backend for frontend service, the data acquisition request to the storage center;
sending, by the storage center, the configuration file corresponding to the target environment identifier to the backend for frontend service according to the version number, in response to the data acquisition request; and
caching, by the backend for frontend service, the configuration file sent by the storage center, and sending, in response to the data acquisition request, the configuration file corresponding to the target environment identifier to the front-end platform.

4. The method according to claim 3, further comprising:
in response to the configuration file corresponding to the target environment identifier is cached in backend for frontend service, when a first time interval between a timestamp of the cached configuration file corresponding to the target environment identifier and a current time is less than a second time interval for the storage center to update the configuration file to the backend for frontend service, sending, by the backend for frontend service, the cached configuration file corresponding to the target environment identifier in response to the data acquisition request.

5. The method according to claim 1, wherein the configuration file further comprises a code name corresponding to branch code associated with the target business environment; and
the generating, by the back-end server, back-end code corresponding to the target business environment according to the target configuration data comprised in the configuration file, comprises:
generating, by the back-end server, the back-end code according to the target configuration data and the code name comprised in the configuration file.

6. The method according to claim 5, wherein the configuration file is a configuration file in a first format, and the generating, by the back-end server, the back-end code according to the target configuration data and the code name comprised in the configuration file, comprises:
converting, by the back-end server, the configuration file in the first format into a configuration file in an intermediate format through a preset script; and
generating, by the back-end server, the back-end code in a second format through a code generator based on the target configuration data and the code name comprised in the configuration file in the intermediate format.

7. A method for data management, executed by a configuration platform, comprising:
obtaining target configuration data configured for a target business environment corresponding to a target environment identifier, wherein the target configuration data is used for defining a function of the target business environment;
generating a configuration file according to the target environment identifier and the target configuration data; and
sending the configuration file to a front-end platform and a back-end server, wherein the configuration file is used for the front-end platform to render and generate a front-end page corresponding to the target business environment according to target configuration data comprised in the configuration file, and the configuration file is used for the back-end server to generate back-end code corresponding to the target business environment according to the target configuration data comprised in the configuration file, wherein the back-end code is used for supporting the function of the front-end page.

8. A computer-readable medium, on which a computer program is stored, wherein when the program is executed by a processor, implements the method for data management according to claim 7.

9. A data management system, comprising:
at least one memory, on which a computer program is stored; and
at least one processor, configured to execute the computer program in the at least one memory, to implement a method for data management, and the method comprises:
obtaining, by the configuration platform, target configuration data configured for a target business environment corresponding to a target environment identifier, wherein the target configuration data is used for defining a function of the target business environment;
generating, by the configuration platform, a configuration file according to the target environment identifier and the target configuration data;
obtaining, by the front-end platform, a configuration file corresponding to the target environment identifier from the configuration platform;
rendering and generating, by the front-end platform, a front-end page corresponding to the target business environment, according to target configuration data comprised in the configuration file;
obtaining, by the back-end server, the configuration file corresponding to the target environment identifier from the configuration platform; and
generating, by the back-end server, back-end code corresponding to the target business environment according to the target configuration data comprised in the configuration file, wherein the back-end code is used for supporting a function of the front-end page.

10. The data management system according to claim 9, wherein the target business environment corresponding to the target environment identifier is established by:
determining, by the configuration platform, the target business environment according to environmental creation information carried in a creation request in response to the creation request used to indicate to create a business environment, wherein the environmental creation information comprises at least one selected from the group of a basic source environment, requirement information associated with the target business environment, and a code name corresponding to branch code associated with the target business environment; and
establishing, by the configuration platform, an association relationship between the target business environment and the target environment identifier according to the target environment identifier indicated by the creation request.

11. The data management system according to claim 9, wherein the data management system further comprises a storage center and a backend for frontend service, and the method further comprises:
sending, by the configuration platform, the configuration file to the storage center;
receiving, by the storage center, the configuration file sent by the configuration platform, allocating a corresponding version number to the configuration file and storing the configuration file; and
the obtaining, by the front-end platform, a configuration file corresponding to the target environment identifier from the configuration platform, comprises:
sending, by the front-end platform, a data acquisition request to the backend for frontend service, wherein the data acquisition request comprises the target environment identifier;
in response to the configuration file corresponding to the target environment identifier is not cached in the backend for frontend service, sending, by the backend for frontend service, the data acquisition request to the storage center;
sending, by the storage center, the configuration file corresponding to the target environment identifier to the backend for frontend service according to the version number, in response to the data acquisition request; and
caching, by the backend for frontend service, the configuration file sent by the storage center, and sending, in response to the data acquisition request, the configuration file corresponding to the target environment identifier to the front-end platform.

12. The data management system according to claim 11, wherein the method further comprises:
in response to the configuration file corresponding to the target environment identifier is cached in backend for frontend service, when a first time interval between a timestamp of the cached configuration file corresponding to the target environment identifier and a current time is less than a second time interval for the storage center to update the configuration file to the backend for frontend service, sending, by the backend for frontend service, the cached configuration file corresponding to the target environment identifier in response to the data acquisition request.

13. The data management system according to claim 9, wherein the configuration file further comprises a code name corresponding to branch code associated with the target business environment; and
the generating, by the back-end server, back-end code corresponding to the target business environment according to the target configuration data comprised in the configuration file, comprises:
generating, by the back-end server, the back-end code according to the target configuration data and the code name comprised in the configuration file.

14. The data management system according to claim 13, wherein the configuration file is a configuration file in a first format, and the generating, by the back-end server, the back-end code according to the target configuration data and the code name comprised in the configuration file, comprises:
converting, by the back-end server, the configuration file in the first format into a configuration file in an intermediate format through a preset script; and
generating, by the back-end server, the back-end code in a second format through a code generator based on the target configuration data and the code name comprised in the configuration file in the intermediate format.
